(19) United States
(12) Patent Application Publication
(10) Pub. No.: US 2004/0069091 A1
(43) Pub. Date: Apr. 15, 2004

(54) Pedal assembly with compensating bushing

(76) Inventor: Brad Menzies, Holly, MI (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 10/271,601

(22) Filed: Oct. 15, 2002

(51) Int. Cl. G05G 1/14

(52) U.S. Cl. 74/560

(57) ABSTRACT

An adjustable pedal assembly including a carrier (14) slidably supported on a hollow rod (12) with first (24) and second (26) wedge members (24) and (26) urged up inclined surfaces (34) and (38) by a bolt (28) and spring (30) interconnecting the wedge members (24) and (26). The wedge members (24) and (26) include wedge flanking surfaces (42) in sliding engagement with lips (40) in the rod (12) for forcing the rod (12) into engagement with a bore (41) in the carrier (14) as the wedge members (24) and (26) are moved upwardly by the inclined surfaces (34) and (36).

### BACKGROUND OF THE INVENTION

1. Field of the Invention

The subject invention relates to an adjustable pedal assembly of the type including a carrier supported by a guide for rectilinear movement along an adjustment path and a pedal supported by the carrier and extending from the carrier to a distal pedal end with a mechanism interacting between the carrier and the guide for urging the guide into engagement with the carrier

2. Description of the Prior Art

Such assemblies are known as is illustrated in U.S. Pat. No. 5,460,061 to Redding et al. the mechanism reacting between the guide and the carrier in Redding et al. is referred in the patent as a slack take-up and includes a lever pivotally attached to the pedal or carrier and adjusted by a screw. Other assemblies simply include a spring reacting between the carrier and guide for taking up slack by biasing the carrier into engagement with the guide.

However, there remains a constant need to improve the slack or lash take-up in such assemblies. One of the benefits of decreasing the slack or lash at the interface between the carrier and guide is that the interface may be manufactured to less tolerances as the slack or lash decreases.

### SUMMARY OF THE INVENTION AND ADVANTAGES

The invention provides a pedal assembly comprising a carrier supported by a guide for rectilinear movement along an adjustment path and a pedal supported by the carrier and extending from the carrier to a distal pedal end. A mechanism interacts between the carrier and the guide for urging the guide into engagement with the carrier. The assembly is characterized by the mechanism including at least one pair of co-acting surfaces inclined relative to the path of movement and movable relative to one another in a wedging action to force the guide into engagement with the carrier.

Accordingly, the subject invention provides an assembly that of decreases the slack or lash at the interface between the carrier and guide to improve performance and whereby the interface may be manufactured to less tolerances.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 is a perspective view of a pedal assembly constructed in accordance with the subject invention;

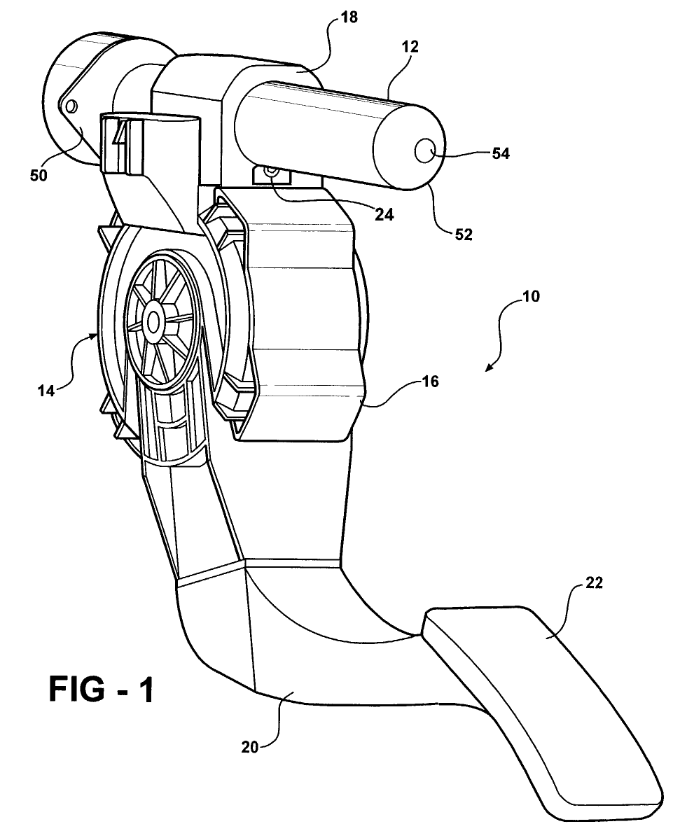

FIG. 2 is a perspective view, partially cutaway and in cross section of the assembly shown in FIG. 1;

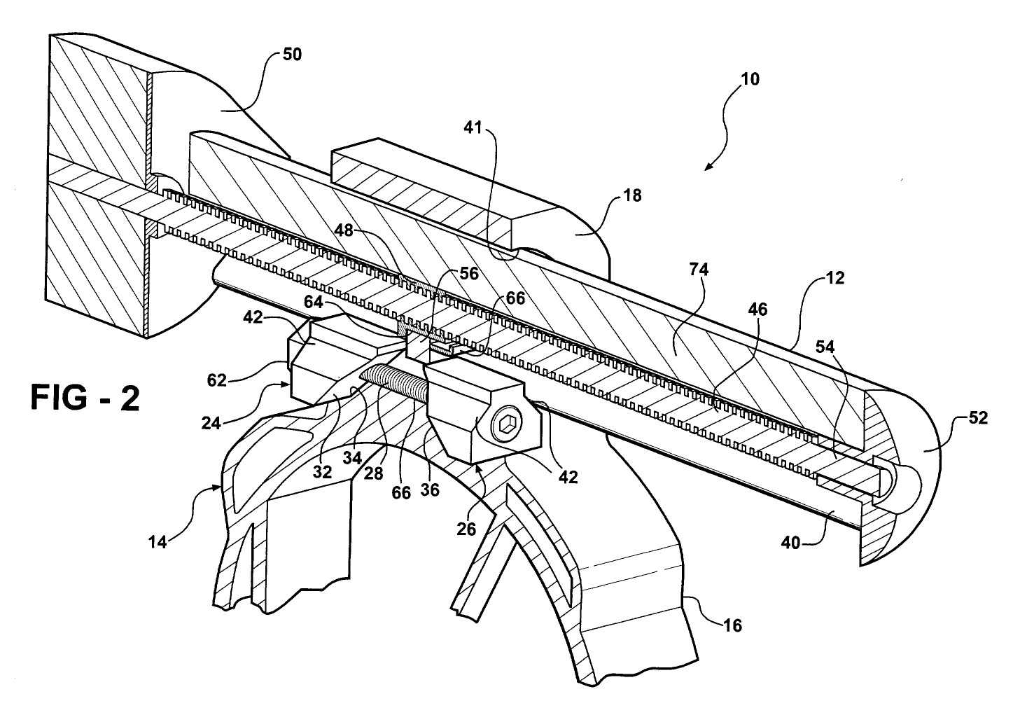

FIG. 3 is an enlarged perspective view like FIG. 2 but further cutaway and in further cross section;

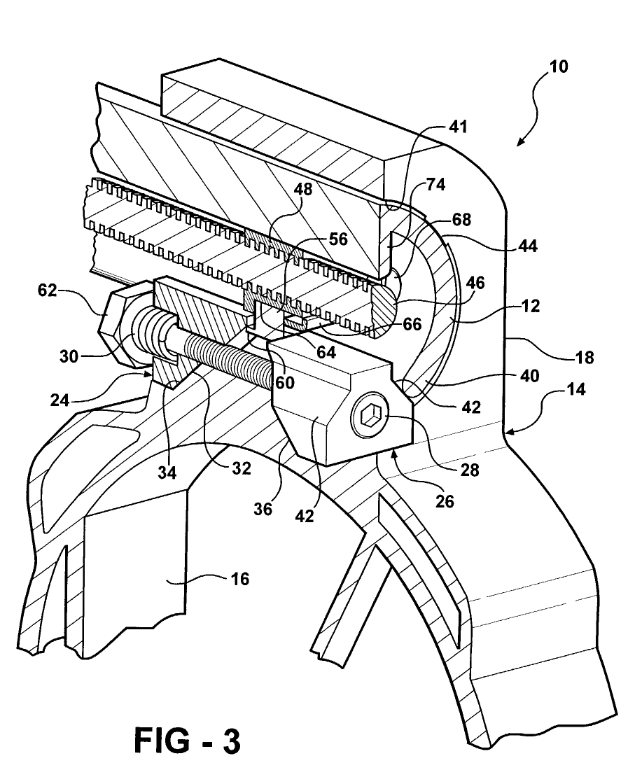

FIG. 4 is a fragmentary view partially in cross section;

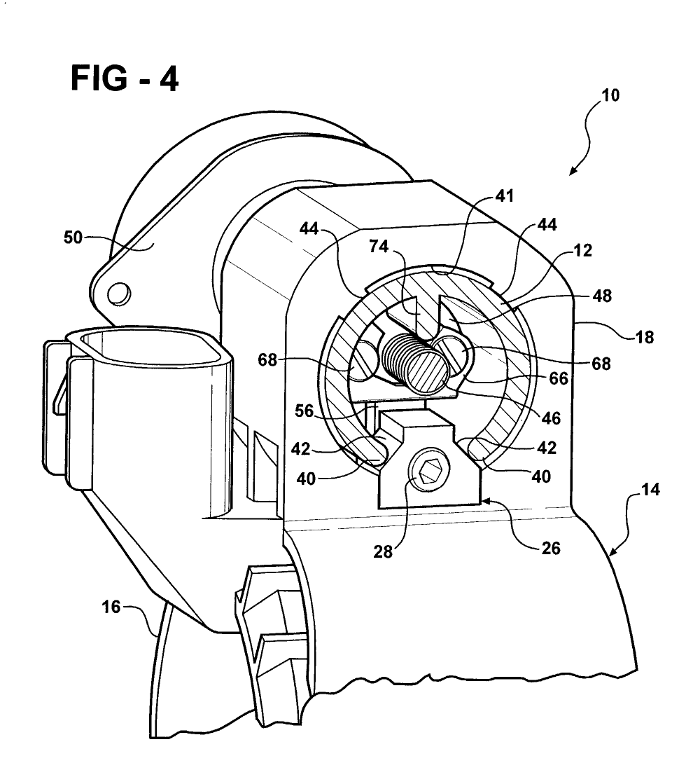

FIG. 5 is an enlarged fragmentary view with the rod and bore of the carrier in cross section; and

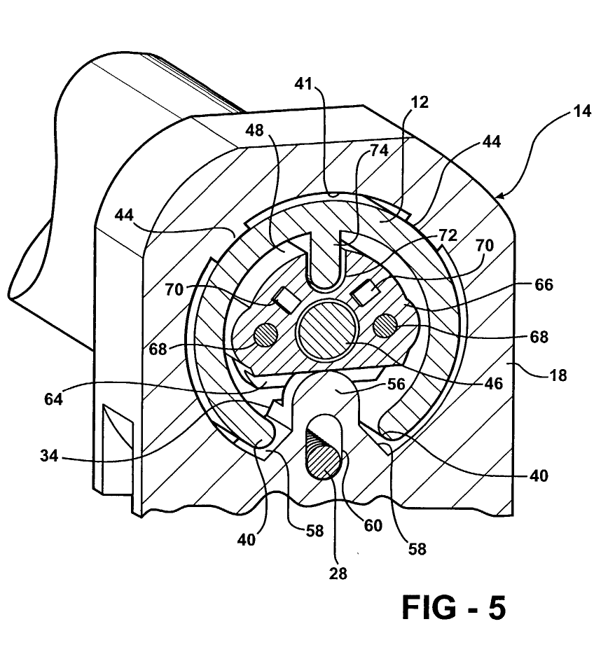

FIG. 6 is an exploded view of the rod and bore components.

### DETAILED DESCRIPTION OF THE PREFERRED EMBODIMENT

Referring to the Figures, wherein like numerals indicate like or corresponding parts throughout the several views, a pedal assembly and the components thereof constructed in accordance with the subject invention are generally shown at 10 in the various Figures.

The assembly 10 includes a guide in the form of a hollow rod 12. A carrier, generally indicated at 14, is supported by the guide rod 12 for rectilinear movement along an adjustment path, i.e., along the axis of the rod 12. The carrier 14 comprises a housing 16 and a hub 18, preferably formed integrally as one piece of plastic. The housing 16 of the carrier 14 rotatably supports a pedal 20 that extends from the carrier 14 to a distal pedal end, which supports a pedal pad 22. The internal components of the housing 16 for pivoting supporting the pedal 20 can be those of the type disclosed in co-pending applications having the Ser. Nos. 09/974,152 and 09/974,667, both filed Oct. 9, 2001 and assigned to the assignee of the subject application.

The assembly includes a mechanism interacting between the hub 18 of the carrier 14 and the guide rod 12 for urging the guide rod 12 into engagement with the carrier 14. More specifically, the mechanism includes first 24 and second 26 wedge members, generally indicated at 24 and 26 respectively, and an adjustment device interconnecting the wedge members 24 and 26, the adjustment device comprising a fastener 28, i.e., a threaded bolt and nut, and a biasing device or spring 30.

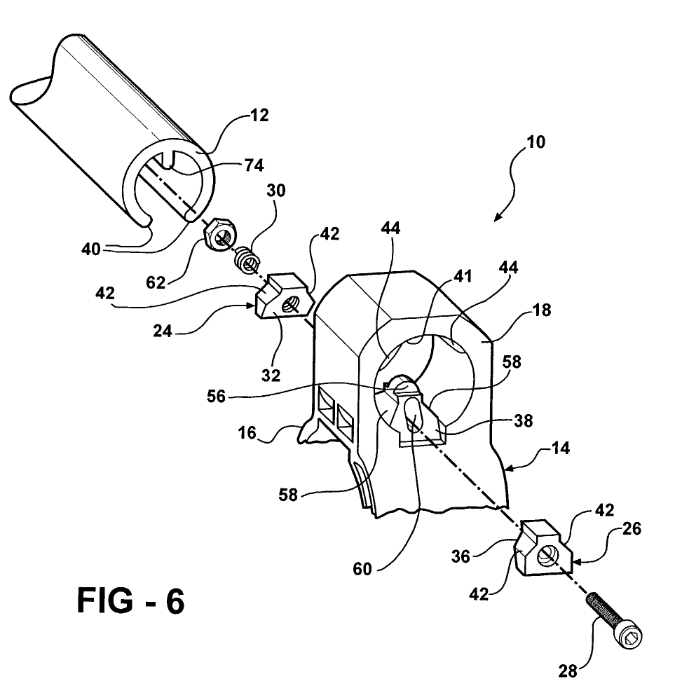

The assembly 10 is characterized by the mechanism including at least one pair of co-acting surfaces 32 and 34 inclined relative to the adjustment path of movement and movable relative to one another in a wedging action to force the guide rod 12 into engagement with the carrier 14. More specifically, the first wedge member 24 is movably supported by the hub 18 of the carrier 14 with one 32 of a first pair of surfaces supported by the first wedge member 24 and the other 34 of the first pair of surfaces supported by the hub 18 of the carrier 14. The mechanism may also include the second wedge member 26 movably supported by the carrier 14 with one 36 of a second pair of surfaces 36 and 38 supported by the second wedge member 26 and the other 38 (FIG. 6) of the second pair of surfaces supported by the hub 18 of the carrier 14. The first 32, 34 and second 36, 38 pair of surfaces being inclined in opposite directions to one another, i.e., the surfaces slant toward one another.

The rod 12 is a hollow tube and includes a slot having circumferentially spaced lips 40 extending along the rod 12. The hub 18 of the carrier 14 presents a bore 41 and the guide rod 12 is slidably supported in the bore 41. The bore 41 includes bearing pads 44 projecting radially inwardly from the interior of the bore 41 for bearing contact with the circumference of the rod 12. As will be appreciated, longitudinal adjustment of the wedge members 24, 26 by tightening the fastener 28 forces the rod 12 into engagement with the pads 44 of the bore 41. The wedge first 24 and second 26 wedge members have wedge flanking surfaces 42 in sliding engagement with the lips 40 for forcing the rod 12 into engagement with the bore 41 as the wedge members 24 and 26 are moved upwardly by the inclined surfaces 34 and 36 in the hub 18. In other words, the adjustment device interconnecting the wedge members 24, 26 adjusts the position of the wedge members 24, 26 longitudinally relative to the hub 18 of the carrier 14 to adjust the amount of force between the bore 41 and the guide rod 12.

A screw 46 is disposed longitudinally within the hollow rod 12 and a nut device 48 threadedly engages the screw 46 and is connected to the hub 18 of the carrier 14 for moving the carrier 14 along the rod 12 in response to rotation of the screw 46. A drive motor 50 is connected to the screw 46 for rotating the screw 46 relative to the rod 12, the motor 50 being supported or attached to the rod 12. A cap 52 is supported in the distal end of the rod 12 and rotatably supports the circular end 54 of the screw 46.

The hub 18 of the carrier 14 includes a finger 56 extending radially into the bore 41 and between the lips 40 of the slot of the rod 12 to a distal end or dome. The surfaces 34, 38 of the first and second pair that are supported by the carrier 14 are disposed on the finger 56 and are inclined upwardly and inwardly toward the distal end. The first 24 and second 26 wedge members are disposed on opposite sides of the finger 56 and longitudinally spaced along the screw 46 for sliding engagement with the inclined surfaces 34, 38 on the finger 56.

The finger 56 includes finger flanking surfaces 58 inclined inwardly and upwardly toward the distal end of the finger 56 and face in opposite directions toward the interior of the bore 41. The finger flanking surfaces 58 and the inclined surfaces 34, 38 on the finger 56 are disposed in a pyramidal configuration.

The finger 56 includes a passage 60 extending therethrough parallel to the screw 46 and the adjustment device includes a fastener bolt 28 and fastener nut 62 interconnecting the first 24 and second 26 wedge members and extending through the passage 60. The adjustment device also includes the biasing device or spring 30 reacting between the fastener 28, 62 and at least one of the wedge members 24, 26 for constantly biasing the first 24 and second 26 wedge members to move against and relative to the surfaces 34, 38 on the finger 56, i.e., for biasing the co-acting surfaces to move relative to one another in the wedging action. The adjustment device may include a spring at each end of the bolt 28 or just at one end as shown.

The nut device 48 is connected to the hub 18 of the carrier 14 by being connected to the distal end of the finger 56. More specifically, the nut device 48 includes a pocket 64 for receiving opposite planar sides of the dome at the top of the distal end of the finger 56 and a retaining plate 66 for retaining the distal end of the finger 56 in the pocket 64. Fastener screws 68, or the like, retain the plate 66 to the nut device 48 and alignment tabs 70 extend through and position the plate 66 on the nut device 48.

The nut device 48 includes a groove 72 and the hollow rod 12 includes a tongue 74 extending radially toward the center of the rod 12 and disposed in the groove 72 for preventing relative rotation between the rod 12 and the nut device 48.

As will be appreciated, the lash or cocking movement between the rod 12 and the bore 41 of the carrier 12 may be minimized or eliminated by tightening the bolt 28 to move the wedge members 24 and 26 longitudinally toward one another whereby the first 32, 34 and second 36, 38 pairs of co-acting inclined surfaces force the wedge members 24 and 26 radially inwardly so that the flanking surfaces 42 of he wedge members 24 and 26 engage the lips 40 of the rod 12 to force the rod 12 into bearing engagement with the pads 44 of the bore 41. The motor 50 and rod 12 are normally attached to a vehicle structure through a support bracket, or the like, whereby the operating position of the pedal 20 may be adjusted relative to the vehicle operator by actuating the electric motor 50 to move the carrier 12 along the rod 12. Once adjusted to a selected operating position, the pedal is rotated about the pivotal connection to the carrier 12 for generating an electrical signal to actuate a vehicle throttle or brake, the electrical generator being disposed in the housing 16. It is also to be understood that, instead of the pedal being pivotally supported by the carrier 12, the subject invention can be used in an adjustable pedal assembly wherein the guide 12 is pivotally supported by a support structure for operating the throttle or brake, i.e., an assembly as illustrated in U.S. Pat. No. 6,109,241 to Engelgau. And the guide may take many configurations other than the circular and hollow rod illustrated.

Obviously, many modifications and variations of the present invention are possible in light of the above teachings. The invention may be practiced otherwise than as specifically described within the scope of the appended claims, wherein that which is prior art is antecedent to the novelty set forth in the “characterized by” clause. The novelty is meant to be particularly and distinctly recited in the “characterized by” clause whereas the antecedent recitations merely set forth the old and well-known combination in which the invention resides. These antecedent recitations should be interpreted to cover any combination in which the incentive novelty exercises its utility. In addition, the reference numerals in the claims are merely for convenience and are not to be read in any way as limiting.

What is claimed is:

1. A pedal (20) assembly comprising;
a guide (12),
a carrier (14) supported by said guide (12) for rectilinear movement along an adjustment path,
a pedal (20) supported by said carrier (14) and extending from said carrier (14) to a distal pedal end (22),
a mechanism interacting between said carrier (14) and said guide (12) for urging said guide (12) into engagement with said carrier (14),
said assembly characterized by said mechanism including at least one pair (32, 34) or (36, 38) of co-acting surfaces inclined relative to said path of movement and movable relative to one another in a wedging action to force said guide (12) into engagement with said carrier (14).

2. An assembly as set forth in claim 1 wherein said mechanism includes a biasing device (30) for biasing said co-acting surfaces to move relative to one another in said wedging action.

3. An assembly as set forth in claim 1 wherein said mechanism includes a first wedge member (24) movably supported by said carrier (14) with one (32) of said pair of surfaces supported by said wedge member and the other (34) of said surfaces supported by said carrier (14).

4. An assembly as set forth in claim 3 wherein said mechanism includes a biasing device (30) for constantly biasing said first wedge member (24) to move relative to said carrier (14) in said wedging action.

5. An assembly as set forth in claim 3 wherein said mechanism includes second pair (36, 38) of surfaces and a second wedge member (26) movably supported by said carrier (14) with one (36) of a second pair of surfaces supported by said second wedge member (26) and the other (38) of said second pair of surfaces supported by said carrier (14), said first (32, 34) and second (36, 38) pair of surfaces being inclined in opposite directions, and an adjustment device interconnecting said wedge members (24, 26) for adjusting the position of said wedge members (24, 26) relative to said carrier (14) to adjust the amount of force between said carrier (14) and said guide (12).

6. An assembly as set forth in claim 5 wherein said adjustment device includes a biasing device (30) for constantly biasing said first (24) and second (26) wedge members to move relative to said carrier (14) in said wedging action.

7. An assembly as set forth in claim 3 wherein said carrier (14) presents a bore (41) and said guide includes a rod (12) slidably supported in said bore (41), said wedge member forcing said rod (12) into engagement with said bore (41).

8. An assembly as set forth in claim 7 wherein said rod (12) is hollow and includes a slot having circumferentially spaced lips (40) extending along said rod (12), said wedge member (24) having wedge flanking surfaces (42) in sliding engagement with said lips (40) for forcing said rod (12) into engagement with said bore (41).

9. An assembly as set forth in claim 8 including a screw (46) disposed longitudinally within said hollow rod (12), a nut device (48) threadedly engaging said screw (46) and connected to said carrier (14) for moving said carrier (14) along said rod (12) in response to rotation of said screw (46).

10. An assembly as set forth in claim 9 wherein said mechanism includes second pair of surfaces (36, 38) and a second wedge member (26) movably supported by said carrier (14) with one (36) of a second pair of surfaces supported by said second wedge member (26) and the other (38) of said second pair of surfaces supported by said carrier (14), said first (32, 34) and second (36, 38) pair of surfaces being inclined in opposite directions, and an adjustment device interconnecting said wedge members (24, 26) for adjusting the position of said wedge members (24, 26) relative to said carrier (14) to adjust the amount of force between said carrier (14) and said guide (12).

11. An assembly as set forth in claim 10 wherein said adjustment device includes a biasing device (30) for constantly biasing said first (24) and second (26) wedge members to move relative to said carrier (14) in said wedging action.

12. An assembly as set forth in claim 10 wherein said carrier (14) includes a finger (56) extending radially into said bore (41) and between the lips (40) of said slot of said rod (12) to a distal end, said surfaces of said first and second pair supported by said carrier (14) being disposed on said finger (56) and inclined upwardly and inwardly toward said distal end with said first (24) and second (26) wedge members disposed on opposite sides of said finger (56) and longitudinally spaced along said screw (46) for sliding engagement with said inclined surfaces (34), (38) on said finger (56).

13. An assembly as set forth in claim 12 wherein said finger (56) includes a passage extending therethrough parallel to said screw (46) and said adjustment device includes a fastener interconnecting said first (24) and second (26) wedge members and extending through said passage.

14. An assembly as set forth in claim 13 wherein said adjustment device includes a biasing spring (30) reacting between said fastener and at least one of said wedge members (24, 26) for constantly biasing said first (24) and second (26) wedge members to move against and relative to said surfaces (34, 38) on to said carrier (14) in said wedging action.

15. An assembly as set forth in claim 13 wherein said nut device (48) is connected to said carrier (14) by being connected to said distal end of said finger (56).

16. An assembly as set forth in claim 15 wherein said nut device (48) includes a pocket (64) for receiving said distal end of said finger (56) and a retaining plate (66) for retaining said distal end of said finger (56) in said pocket (64).

17. An assembly as set forth in claim 16 including fasteners for securing said retaining plate (66) to said nut device (48).

18. An assembly as set forth in claim 15 wherein said finger (56) includes finger flanking surfaces (58) inclined inwardly and upwardly toward said distal end of said finger (56) and facing in opposite directions toward the interior of said bore (41), said finger flanking surfaces (58) and said inclined surfaces (34, 38) on said finger (56) being disposed in a pyramidal configuration.

19. An assembly as set forth in claim 18 wherein said nut device (48) includes a groove (72) and said hollow rod (12) includes a tongue (74) extending radially toward the center of said rod (12) and disposed in said groove (72) for preventing relative rotation between said rod (12) and said nut device (48).

20. An assembly as set forth in claim 19 including a drive motor (50) connected to said screw (46) for rotating said screw (46) relative to said rod (12).
